(19) United States
(12) Patent Application Publication
(10) Pub. No.: US 2026/0277775 A1
(43) Pub. Date: Sep. 17, 2026

(54) Predictive Canary Testing

(71) Applicant: TELEFONAKTIEBOLAGET LM ERICSSON (PUBL), Stockholm (SE)

(72) Inventors: Ganesh Del Grosso, Bourg-la-Reine (FR); Illyyne Saffar, Le Plessis-Robinson (FR); I-Tang Hiu, Paris (FR); Aurelie Boisbunon, Massy (FR)

(73) Assignee: TELEFONAKTIEBOLAGET LM ERICSSON (PUBL), Stockholm (SE)

(21) Appl. No.: 19/167,913

(22) PCT Filed: Mar. 23, 2023
(86) PCT No.: PCT/IB2023/052883

§ 371 Date: Sep. 23, 2025

(51) Int. Cl. G06F 11/3668; G06F 8/71

(52) U.S. Cl. CPC G06F 11/3688; G06F 8/71

(57) ABSTRACT

A method and system for transitioning data traffic from a first software component to a second software component. The data traffic is split into production data traffic and test data traffic, which is then split between a baseline component and a canary component. Counters are obtained for the baseline and canary components, and a distribution of the counters is computed for the baseline and canary components. An additional portion of the production data traffic is transitioned to the baseline component and a new distribution of the counters is computed for the baseline component. Using the distribution and new distribution of the counters for the baseline component, a new distribution for the counters is predicted for the canary component for an equal increase of data traffic. Depending on the predicted new distribution, the data traffic is transitioned to the second software component or is rolled back to the first software component.

### TECHNICAL FIELD

The present disclosure relates to canary testing and to the use of machine learning for predictive canary testing.

### BACKGROUND

Canary testing is a technique for continuous integration in which a new version of an application, referred to as the canary, is live tested on a small set of users. The canary is tested under a specific context, meaning a specific number of users satisfying certain properties. The performance of the canary is compared to that of a baseline, and if the canary is performing as expected, it is deployed. The baseline is a stable version of the application which is deployed in the same context as the canary (same number of users satisfying the same properties).

In cloud-radio access network (C-RAN), canary testing is applied by progressively increasing the traffic that goes through the canary, which, in this case, represents a new version of a network application. This process is illustrated in FIG. 1, in which a certain amount of traffic is redirected towards the canary and the performance of the canary is verified. If the canary is not behaving as expected, then the application is rolled back to its previous version, otherwise the traffic going through the canary is increased and the process is repeated.

### SUMMARY

There is provided a computer implemented method for transitioning data traffic from a first software component to a second software component. The method comprises splitting the data traffic into production data traffic and test data traffic and splitting the test data traffic between a copy of the first software component and a copy of the second software component. The method comprises obtaining counters for the copy of the first software component and for the copy of the second software component and computing a distribution of the counters for the copy of the first software component and for the copy of the second software component. The method comprises transitioning a portion of the production data traffic to the test data traffic and directing the transitioned portion of the production traffic to the copy of the first software component. The method comprises computing a new distribution of the counters for the copy of the first software component. The method comprises using the distribution of the counters and the new distribution of the counters for the copy of the first software component, predicting a new distribution for the counters of the copy of the second software component for an increase of data traffic equal to the portion of the production data traffic. The method comprises, based on comparing the computed new distribution of the counters for the copy of the first software component and the predicted new distribution for the counters of the copy of the second software component or on comparing counters sampled from the computed new distribution and from the predicted new distribution, transitioning the data traffic to the second software component or rolling back the data traffic to the first software component.

There is provided a system operative to transition data traffic from a first software component to a second software component. The system comprises processing circuitry and a memory. The memory contains instructions executable by the processing circuitry whereby the system is operative to split the data traffic into production data traffic and test data traffic and split the test data traffic between a copy of the first software component and a copy of the second software component. The system is operative to obtain counters for the copy of the first software component and for the copy of the second software component and compute a distribution of the counters for the copy of the first software component and for the copy of the second software component. The system is operative to transition a portion of the production data traffic to the test data traffic and direct the transitioned portion of the production traffic to the copy of the first software component. The system is operative to compute a new distribution of the counters for the copy of the first software component. The system is operative to use the distribution of the counters and the new distribution of the counters for the copy of the first software component to predict a new distribution for the counters of the copy of the second software component for an increase of data traffic equal to the portion of the production data traffic. The system is operative to, based on comparing the computed new distribution of the counters for the copy of the first software component and the predicted new distribution for the counters of the copy of the second software component or on comparing counters sampled from the computed new distribution and from the predicted new distribution, transition the data traffic to the second software component or rolling back the data traffic to the first software component.

There is provided a non-transitory computer readable media having stored thereon instructions for transitioning data traffic from a first software component to a second software component. The instructions comprise splitting the data traffic into production data traffic and test data traffic and splitting the test data traffic between a copy of the first software component and a copy of the second software component. The instructions comprise obtaining counters for the copy of the first software component and for the copy of the second software component and computing a distribution of the counters for the copy of the first software component and for the copy of the second software component. The instructions comprise transitioning a portion of the production data traffic to the test data traffic and directing the transitioned portion of the production traffic to the copy of the first software component. The instructions comprise computing a new distribution of the counters for the copy of the first software component. The instructions comprise using the distribution of the counters and the new distribution of the counters for the copy of the first software component, predicting a new distribution for the counters of the copy of the second software component for an increase of data traffic equal to the portion of the production data traffic. The instructions comprise, based on comparing the computed new distribution of the counters for the copy of the first software component and the predicted new distribution for the counters of the copy of the second software component or on comparing counters sampled from the computed new distribution and from the predicted new distribution, transitioning the data traffic to the second software component or rolling back the data traffic to the first software component.

The method and system provided herein present improvements to the way canary testing operates.

### BRIEF DESCRIPTION OF THE DRAWINGS

FIG. 1 is a block diagram illustrating a standard process for canary testing in C-RAN, according to the prior art.

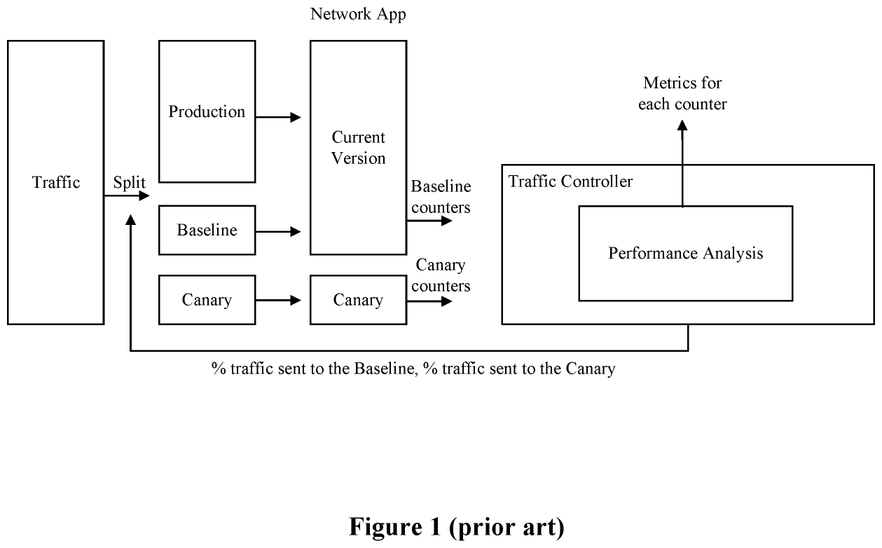

FIG. 2 is a block diagram illustrating a process for canary testing in C-RAN, according to the proposed solution.

FIG. 3 is a flowchart illustrating some steps executed in the traffic controller.

FIG. 4 is a schematic illustration of some steps executed in the performance analyzer.

FIG. 5 is a sequence diagram illustrating some steps and messages exchanged between the canary executor, the traffic controller and the transfer learning unit.

FIG. 6 is a block diagram illustrating an example architecture.

FIG. 7 is a flowchart of a method for transitioning data traffic from a first software component to a second software component.

FIG. 8 is a schematic illustration of a hardware in which steps and/or method described herein can be executed.

FIG. 9 is a schematic illustration of a virtualization environment in which the different steps and hardware components described herein can be deployed.

### DETAILED DESCRIPTION

Various features will now be described with reference to the drawings to fully convey the scope of the disclosure to those skilled in the art.

Sequences of actions or functions may be used within this disclosure. It should be recognized that some functions or actions, in some contexts, could be performed by specialized circuits, by program instructions being executed by one or more processors, or by a combination of both.

Further, computer readable carrier or carrier wave may contain an appropriate set of computer instructions that would cause a processor to carry out the techniques described herein.

The functions/actions described herein may occur out of the order noted in the sequence of actions or simultaneously. Furthermore, in some illustrations, some blocks, functions or actions may be optional and may or may not be executed; these are generally illustrated with dashed lines.

At least some aspects of the techniques described herein may be implemented using artificial intelligence, which comprises a variety of techniques as would be apparent to a person skilled in the art, including machine learning techniques. Machine learning techniques include neural network (NN), or artificial neural network (ANN), and both terms may be used interchangeably herein. In some contexts, an Artificial Neural Network could include biological portions.

Previous work has addressed the issue of seasonal changes by attempting to forecast the behavior of the canary. However, long short-term memory (LSTM) networks were used, which must be trained and deployed in the cloud, taking up resources from other network applications. Since the number of resources allocated to control and analyze the performance of the canary is limited, any feasible solution must be efficient and cheap in terms of memory and computational power.

Currently, the most efficient and cheap approaches for performance analysis of the canary in C-RAN are anomaly detection-based solutions, which take as input the distributions of counters produced by the canary and the baseline and output a decision indicating whether or not the behavior of the canary was found to be anomalous (i.e., having different distributions) with respect to that of the baseline.

For example, canary testing can be used in the context of packet processing function (PPF). A central unit user plane (CU-UP) node hosts the user plane part of the packet data convergence protocol (PDCP) of a gNodeB central unit (gNB-CU). The PDCP performs internet protocol (IP) header compression, ciphering, and integrity protection. The PDCP also handles retransmissions, in-sequence delivery, and duplicate removal in the case of handover. The CU-UP node terminates the E1 interface connected with the gNB-CU control plane (gNB-CU-CP) and the F1-U interface connected with the gNB-decentralized unit (gNB-DU).

PPF is the name of the complete helm chart used to deploy an actual instance of a CU-UP pod. This PPF component receives as input the traffic and outputs counters. Counters are key performance indicators (KPIs) based on the received traffic.

Canary upgrade is an engineering process that reduces the risk during the upgrade of a software component or service. It initializes a new instance with a new software version, and this new instance is tested by routing some user equipment (UE) traffic or application programming interface (API) calls towards it. This occurs as existing instances continue to run the current software version at the same time for other users. If the test is unsuccessful, then the new instance with the new software version is terminated. If the test is successful, then the upgrade can continue, and a rolling upgrade (an upgrade of a software version, performed without a noticeable down-time or other disruption of service) can be done until all the instances that realize the software component or service have been upgraded to the new software version.

The canary upgrade process can happen at any time. Depending on the hour of the day, the traffic can be significantly different. For instance, during commuting time, the traffic can be much heavier than between commuting times. Another example is that, at some dates (like some holidays), the traffic will suddenly increase abnormally.

Since there can be multiple CU-UP in one network, a canary upgrade can also happen at a different place in a radio access network. Depending on the location of the CU-UP, the traffic can also be significantly different. For instance, a CU-UP located in an urban place will receive most of the time more traffic than a CU-UP located in a rural zone.

The counters that are used by one of the existing canary testing solutions, the “Kolmogorov-Smirnov” algorithm, are described in the following table:

| COUNTER NAME | DESCRIPTION |
|---|---|
| no_of_per_rpup_packet_{—} | Number of data radio bearer (DRB) packets |
| disc_gtpu_header_invalid | (according to PDCP) discarded in downlink or |
| | uplink because of reasons not associated with |
| | link objects. |
| per_drb_rp_up_packet_rec_ul | Total number of packets (PDCP Packet Data |
| | Units (PDUs)) received for each quality class |
| | indicator (QCI) from uplink radio processing |
| | user plane. Stepped when uplink (UL) PDCP |
| | PDUs are received for each QCI. |
| per_drb_s1_u_packet_trans_ul | Total number of packets (PDCP Service Data |
| | Units (SDUs)) transmitted for each QCI to an |
| | S1U uplink. Stepped when downlink (DL) |
| | PDCP SDUs are sent for each QCI. |
| no_of_pdcp_packet_disc_other | Number of DRB packets (PDCP) discarded in |
| | downlink or uplink because of reasons not |
| | associated with link objects. |
| no_of_pdcp_packet_disc_no_{—} | Number of DRB packets (PDCP) discarded in |
| context | downlink or uplink because of reasons not |
| | associated with link objects and without |
| | context. |
| per_drb_s1_u_packet_rec_dl | Total number of packets (PDCP SDUs) received |
| | for each QCI from SIU downlink interface. |
| | Stepped when DL PDCP SDUs are received for |
| | each QCI. |
| per_drb_rp_up_packet_trans_dl | Total number of packets (PDCP PDUs) |
| | transmitted for each QCI (nine for voice) to |
| | downlink radio processing user plane. Stepped |
| | when DL PDCP PDUs are transmitted for each |
| | QCI. |

This is an example list of the possible counters that can be used for testing in C-RAN, it is not an exhaustive list.

For each of the seven counters listed in the above table there is an associated list of values.

To render a judgement (for deciding if the canary testing is conclusive), an algorithm compares the distribution of the baseline counters (the counters coming from the PPF in production) with the canary counters (the counters coming from the candidate PPF). For every counter, a statistical test, such as the “two-sample Kolmogorov-Smirnov” test, verifying a null hypothesis, positing that the baseline and canary counter values are drawn from the same underlying distribution, is executed. The two-sample Kolmogorov-Smirnov test compares two empirical distribution functions. The equality of the underlying distributions is determined by the output of the test, compared to a threshold that depends on the size of each sample and on a level parameter α, usually set to 0.05.

If the result of the two-sided statistical test rejects the null hypothesis (the underlying distribution is the same for both samples) for any of the counters, the verdict will be “NO_GO”. Otherwise, it will be “GO” (null hypothesis verified).

Any network functions released as a microservice can be canary tested in the manner described above.

Canary testing allows for zero downtime but has the risk of deteriorating the quality of experience of users exposed to the new version of the application. Furthermore, current implementations do not consider possible downgrades in performance due to traffic increases or seasonal changes. An application might be able to handle a certain amount of traffic while being tested, but that does not guarantee correct behavior when traffic is increased.

The previously presented solutions disregard the possibility that the ‘anomalous’ behavior of the canary might actually correspond to an improvement over the baseline. Additionally, when the behavior of the canary is determined to be anomalous, these solutions fail to explain why.

In terms of performance analysis, previous implementations have considered the two-sample Kolmogorov-Smirnov test, which computes the supremum of the absolute difference between the cumulative distribution functions of two samples of a random variable (in this case one of the counters), and therefore does not consider in which direction the canary distribution shifts with respect to the baseline (improvement or degradation).

Herein, a solution for canary testing that predicts the performance of the canary before increasing its traffic is proposed, thus preventing possible deterioration of the user experience. The solution consists of a traffic controller unit which integrates performance analysis, and a transfer learning unit, which learns and predicts the behavior of the canary.

The traffic controller decides the amount of traffic that is deviated from production into the canary and baseline. Initially, both canary and baseline are handling the same amount of traffic. If the performance of the canary is better (or equal) than that of the baseline, the traffic of the baseline is increased first. Using the counters for the baseline (which now handles an increased amount of traffic), the solution uses transfer learning to learn a map that predicts the canary counters as if it were running under the same traffic increase. Using this prediction, the performance of the canary is evaluated. If, based on the prediction, the performance of the canary improves over the baseline, the traffic of the canary is increased to match that of the baseline. Then, the controller goes back to the initial state in which baseline and canary handle the same amount of traffic, and the performance of the canary can be verified.

The performance analyzer determines if the performance of the canary is better than that of the baseline at any given time. The analyzer runs an ensemble of statistical tests to compare the counters of the baseline to those of the canary individually for each counter. The solution suggests tests that will determine if the performance of the canary is better than that of the baseline, but the specific set of tests and way to combine them will depend on the use case.

In particular, the Earth Mover's Distance is considered, which produces a measurement of the similitude between the shapes of the distributions. This is more useful in detecting faulty behavior of the canary than simply comparing the distance between the distributions. The solution also includes comparing the average values of counters, which gives a first indication on whether the performance of the canary is improving over that of the baseline.

The solution offers the best of the existing approaches (anomaly detection and LSTM networks) for the following reasons. It prevents the deterioration of the user experience by predicting the performance of the canary before the number of users is increased. Likewise, it can be used to predict the performance of the canary in a future context, thus preventing deterioration of the user experience due to seasonal changes. The algorithms used for forecasting the canary performance are light and efficient, freeing up valuable network resources for other applications. While previous solutions merely detect if the canary is anomalous with respect to the baseline, the solution determines if the canary performs better than the baseline or not. This prevents false rejection of the canary. The decision taken by the performance analyzer is based on an ensemble of statistical tests for each counter. The output of these statistical tests can be used to explain why the canary failed, helping the application developers to correct and improve their application.

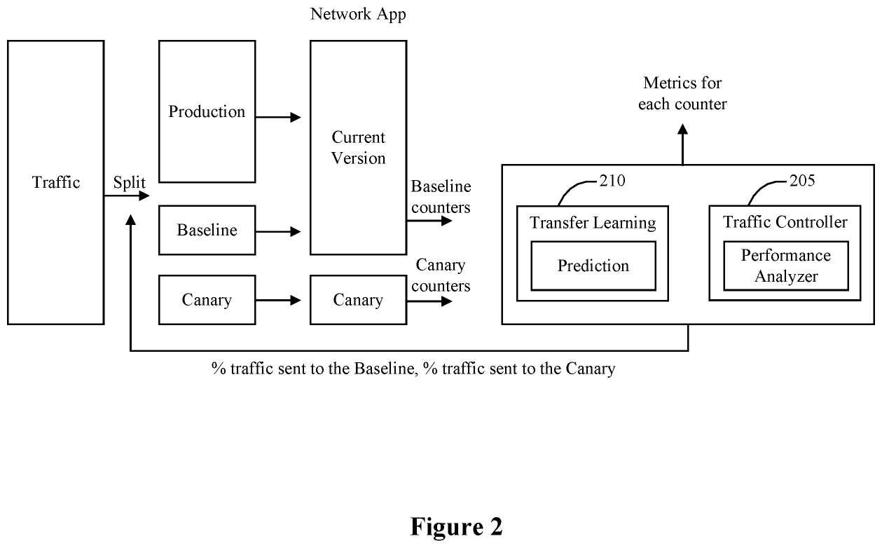

The solution is composed by two main components, the traffic controller unit 205, which takes as input the baseline and canary counters and outputs an allocation of traffic for the baseline and canary, and the transfer learning unit 210, which learns to map between different traffic loads and predicts the canary counters at increased traffic. An overview of the system is provided by FIG. 2.

To predict the behavior of the canary, the transfer learning unit uses e.g., optimal transport or similar techniques to learn a map from counters at time t to counters at time t+1. This information is forwarded to the traffic controller, which evaluates the predicted performance of the canary at increased traffic.

The logic of the traffic controller and the techniques used for transfer learning are provided below. To be able to decide the traffic allocation for the canary, the traffic controller needs to evaluate its performance. The evaluation is provided by the performance analyzer, which is also described below.

### Predictive Canary Testing

One of the objects of the solution proposed herein is to increase the traffic going through the baseline only and use its evolution to estimate how the canary would evolve if its traffic was to be increased too. If the evolution does not seem to cause abnormal behavior, then the canary can be actually tested with increased traffic.

A more formal explanation is provided in the next paragraphs.

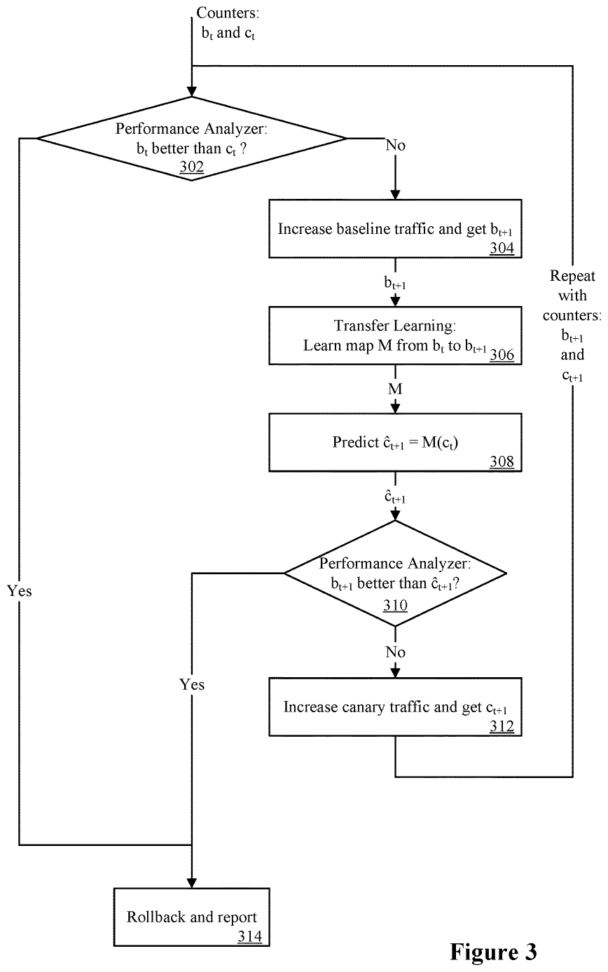

Turning to FIG. 3, let:
bₜ be the counters of the baseline at time step t,
and cₜ be the counters of the canary.

Initially the traffic load of the canary is equal to that of the baseline. The first step, 302, is to verify that the canary does not show an anomalous or faulty behavior, and that its performance is similar or improving on that of the baseline. If the behavior of the canary is as expected or shows an improvement over the baseline, the traffic of the baseline is increased, step 304. Using a known scheme for transfer learning such as optimal transport, the shift in the distribution of counters bₜ is learnt after the traffic going through the baseline is increased bₜ₊₁, step 306. A map M is learnt from bₜ to bₜ₊₁, which captures the evolution of the counters when the traffic is increased. Using M, known counters of the canary cₜ are mapped to an estimate cₜ₊₁, which predicts the behavior of the canary for an increased traffic load, step 308. Using estimate cₜ₊₁ the performance is compared to that of the baseline bₜ₊₁ and a prediction whether the canary will show anomalous behavior on an increased amount of traffic is made, step 310. If the prediction shows that the canary behaves as expected or improves compared with the baseline, the traffic going through the canary is increased, step 312, and the process is repeated from the first step, but with the new traffic loads bₜ₊₁ and cₜ₊₁. If the verification of the canary indicates that it is faulty, the application is rolled back to its previous version, step 314.

In one embodiment, the traffic can be increased statically, i.e., by a fixed amount at each step. However, in some other embodiments the traffic can be increased as a linear function of the performance increase of a counter, or of a particular combination of counters.

### Catching Seasonality Changes

A similar scheme can be used to predict the changes in the behavior of the canary due to seasonal changes. The idea is to observe the behavior of the baseline for distinct periods of time. For example, let's assume that bₜ corresponds to the counters measured during a low traffic period, and bₜ₊₁ corresponds to the counters measured during a high traffic period. These measurements can be done without putting the quality of service at risk, since the baseline is a stable version of the network application. Using these measurements, a map M can be learnt from a low traffic period to a high traffic period. Finally, using this map, the canary can be tested in a low traffic period, where less users are exposed to the possibly faulty version of the new application, and it is possible to predict how it will behave when deployed in a higher traffic period.

### Transfer Learning

This step consists in learning at time step t how to map the counters produced by traffic load t, bₜ, called “source feature space”, to the counters produced by t+1, bₜ₊₁, called “target feature space”. In artificial intelligence (AI), mapping one feature space to another, while these two are similar but different, is a typical problem of transfer learning.

Since the proposed performance analyzer computes statistics on the counters to make its decision, the transfer learning methods considered should act directly in the input space, increasing the similitude of the target features (counters for traffic load t+1) to the source features (counters for traffic load t). This should be used as a guideline to choose an appropriate transfer learning algorithm. This selection can be achieved by a person skilled in the art without undue experimentation.

In some embodiments, optimal transport can be used to map the source features to the target features. In this case, the idea is to learn a map that minimizes the Wasserstein distance between the two distributions. In the case of one-dimensional data (which is the case here), there is a closed form solution to learn a pushforward distribution (a way to sample from an unknown distribution) that can be used to map the source feature space into the target feature space. This solution is explained in detail in the following. The reader is also invited to refer to “Rachev, Svetlozar T., Ludger Ruschendorf, Mass Transportation Problems, Volume I. Theory, Vol. 1, Springer, 1998”.

The first step is to compute the cumulative distribution function (CDF) for the source counters (counters at time step t) and the CDF for the target counters (counters at time step t+1). A CDF can be computed from a sample (in this case a set of values for the counter) by computing a histogram of the sample and then normalizing it to obtain a discrete empirical distribution. Finally, the CDF is computed from the sums of the discrete empirical distribution.

Let Fₜ be the CDF of the counters at time step t, similarly let Fₜ₊₁ be the CDF of the counters at time step t+1. The map M from traffic load at t to traffic load at t+1 is given by

$$M = {F}_{t + 1}^{- 1} ∘ {F}_{t} , where {F}_{t + 1}^{- 1}$$

is the inverse function of Fₜ₊₁. This result holds for the continuous case (with continuous CDFs), however, a way to work around this was found by sampling from the discrete CDFs and their inverses (this is described below). Using this solution, it is possible to sample from the distribution of counters at t+1 by first sampling from the distribution of counters at t and then using the pushforward M. The pushforward M can be learnt on the baseline counters bₜ and bₜ₊₁ and be applied to sample cₜ₊₁ from cₜ. One such map should be learnt individually for each counter.

There exists an alternative solution tailored to the discrete case (discrete probability mass functions PMFs), in which the problem is posed as a linear programming problem and a matrix is learnt allowing to sample from the target distribution (the distribution of counters at t+1). The reader is invited to refer to “Galichon, Alfred, Optimal Transport Methods in Economics, Princeton University Press, 2016”. In practice both solutions allow to map from counters at t to counters at t+1.

Some transfer learning methods act directly on the feature space, while others require to compute empirical distribution functions and their CDFs. The following explains how to perform these computations.

To compute the empirical distribution of a counter, the maximum and minimum values obtained for that counter should be computed. These maximum and minimum values define a closed interval in the real line, which is divided into bins. The size of the bins is determined by the length of the interval divided by the number of bins. The number of bins should be around one order of magnitude smaller than the number of samples for that counter. For each bin, to estimate the probability of the counter having a value inside that bin, the number of samples that fall inside that bin is counted, then that number is divided by the total number of samples. For each bin, the value corresponding to its center is assigned to the bin, and its probability is assigned to that value. This forms a discrete empirical distribution. The CDF is computed by the partial sums of the empirical distribution.

To sample from the inverse of a discrete CDF, an input probability is taken, the bin in the CDF that corresponds to that probability is found, the counter value corresponding to the center of the bin plus some gaussian noise with zero mean and standard deviation equals half the size of the bin is then output.

In some embodiments, other methods could be used instead of optimal transport. Two examples are provided:
Subspace alignment, which consists in first projecting each feature space into a smaller subspace, e.g., by decomposing it into principal component analysis (PCA) or singular value decomposition (SVD), and then finding a map between source (baseline) and target (canary) so that they are close to each other (using e.g., Bregman divergence).
Maximum mean discrepancy (MMD), which is a distance measured between two marginal distributions embedded in a reproducing kernel Hilbert space. The MMD between two distributions is zero if and only if the two distributions are the same. Minimizing the MMD through a feature map can be used as a method for Transfer Learning.

### Performance Analyzer

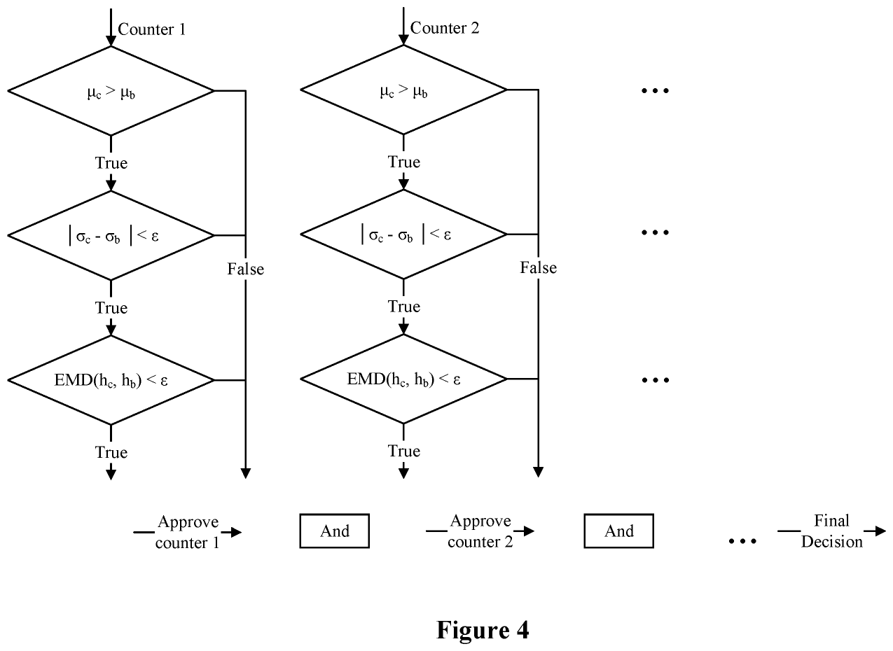

The counters are analyzed using a set of statistical tests, whose results can be combined in different ways, depending on the use case. FIG. 4 suggests a configuration of the performance analyzer. Every counter is analyzed separately, and a decision is taken on an individual level. After that, these decisions are combined to produce a global decision on whether the canary improves over the baseline or not.

For some counters, an increase or a decrease of the value of some statistic (e.g., the mean) leads to an improvement in performance. Thus, it makes more sense to test the increase or decrease of a statistic rather than to test the change or the difference in that statistic. Testing an increase in a statistic constitutes a one-sided or one-tailed test, as opposite to testing the change or the difference in the statistic (two-sided or two-tailed test). Previous solutions for canary testing have only considered two-sided tests. Herein, one-sided tests are considered as well.

In some embodiment, the statistical test used for a counter can be:
Mean comparison: consider a particular counter and let μ_{c} be the average of that counter for the canary, and similarly μ_{B} for the baseline. If μ_{c}>μ_{B}, then the canary is said to improve over the baseline for that counter. This constitutes a one-sided test.
Standard deviation comparison: consider a particular counter and let σ_{c} be the standard deviation of that counter for the canary, and similarly σ_{B} for the baseline. If |σ_{c}−σ_{B}|>ε for a given ε, then the canary is said to improve over the baseline for that counter.
Earth mover's distance (EMD): let EMD denote the earth mover's distance between two probability density functions. Consider a particular counter and construct a normalized histogram h_{c} for the counter of the canary, similarly, construct h_{B} for the counter of the baseline. If EMD(h_{C}, h_{B})<ε for a given ε, then the canary is said to improve over the baseline for that counter.

The statistical tests are performed separately for each counter, and their decisions can be combined in different ways depending on the use case:
In some embodiments it can be sequential: i.e., the statistical tests are performed sequentially. If at any stage in the sequence the canary is rejected for a counter, the test is aborted, and the application is rolled back.
In some embodiments it can be the average: a normalized score is produced for each test and the normalized scores are combined by taking the average.
In some embodiments it can be a weighted sum: normalized scores are combined in a weighted sum. The weights are learned using trained data acquired from previous deployments. This option is the most expensive in terms of computational resources and requires additional data.

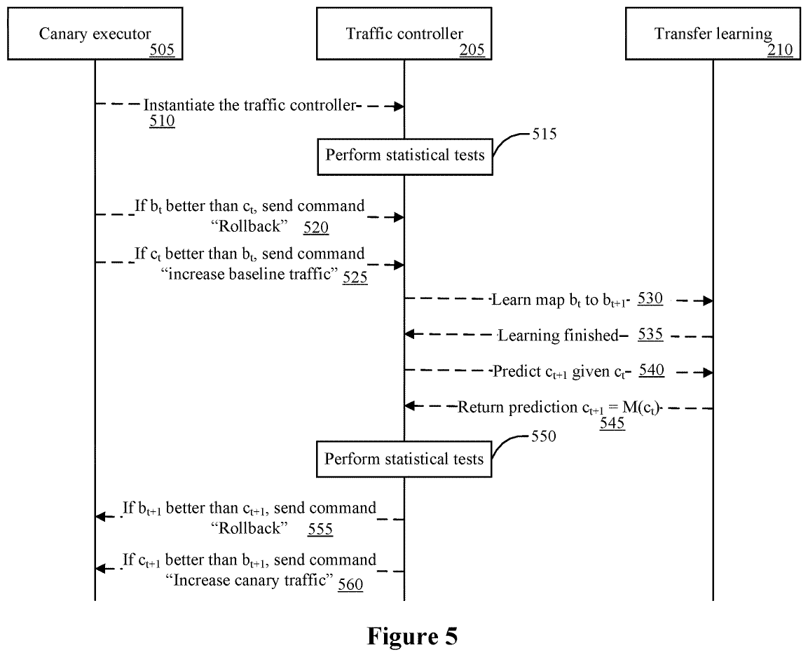

FIG. 5 presents an example implementation of the solution, in which two new microservices (“Traffic controller” and “Transfer learning”) are created and one existing microservice (“Canary executor”) is modified. The sequence diagram models the interaction in a timely manner between the three microservices.

In step 510, the canary executor 505 instantiates the traffic controller 205. In step 515, the traffic controller 205 performs statistical tests. In step 520, if the canary executor 505 determines that bₜ (the baseline) is better than cₜ (the canary), it sends a command to the traffic controller 205 to rollback. If the canary executor 505 determines that cₜ (the canary) is better than bₜ (the baseline), it sends a command to the traffic controller 205 to increase the baseline traffic, step 525. The traffic controller 205 requests the transfer learning unit 210 to learn the map from bₜ to bₜ₊₁, step 530. The transfer learning unit 210 sends a message indicating that learning is finished at step 535. At step 540, the traffic controller 205 requests that the transfer learning unit predicts cₜ₊₁ given cₜ. The transfer learning unit 210 returns the prediction cₜ+1=M(cₜ), step 545. In step 550, the traffic controller 205 performs statistical tests again. If the prediction bₜ₊₁ is better than the prediction cₜ₊₁, the traffic controller 205 sends a command to the canary executor 505 to rollback, step 555. If the prediction cₜ₊₁ is better than the prediction bₜ₊₁, the traffic controller 205 sends a command to the canary executor 505 to increase the canary traffic, step 555.

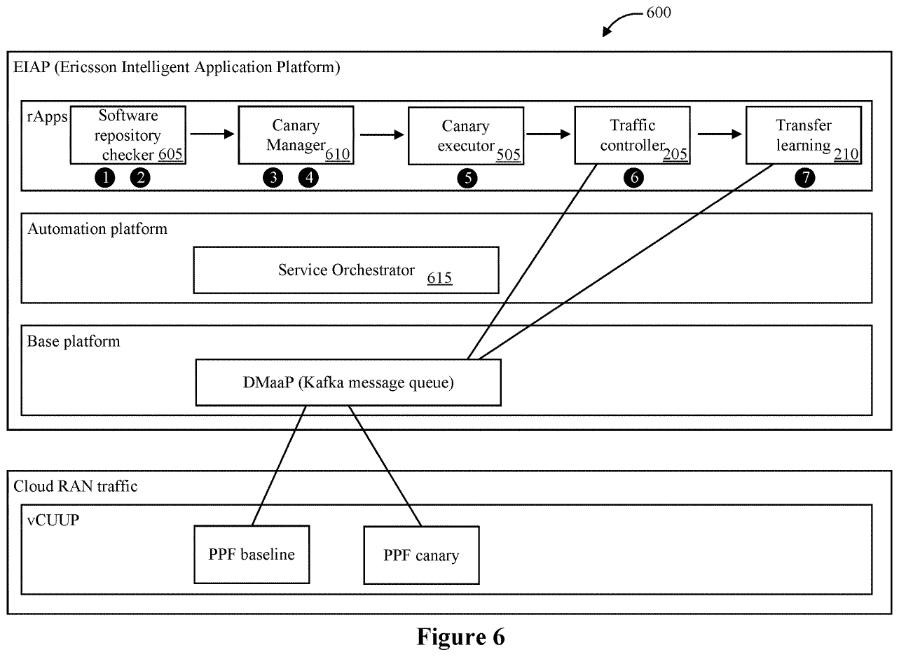

FIG. 6 illustrates an architecture 600 in which the solution can be implemented. In a first step, a software repository checker 605 gets the latest PPF package from a software catalog and compares it with the current version in the software orchestrator (SO) 615. In the second step, the software repository checker 605 notifies the canary manager 610 about new software version. In the third step, the canary manager 610 triggers the canary software executor 505 and listens for a “canary step status”. In a fourth step, the canary manager updates the canary manager user interface (UI). In the fifth step, the canary executor 505 instantiates the canary and the traffic controller 205, sends a status to the canary manager 610, changes the amount of traffic towards production, baseline and canary and removes older PPF when no longer needed. In the sixth step, the traffic controller 205 executes the algorithm, as defined in FIG. 3, sends results (rollback, increase amount of traffic) to the canary executor 505 and sends a command to the transfer learning unit 210. In the seventh step, the transfer learning unit 210 executes the transfer learning process upon traffic controller query and sends the map to traffic controller 205.

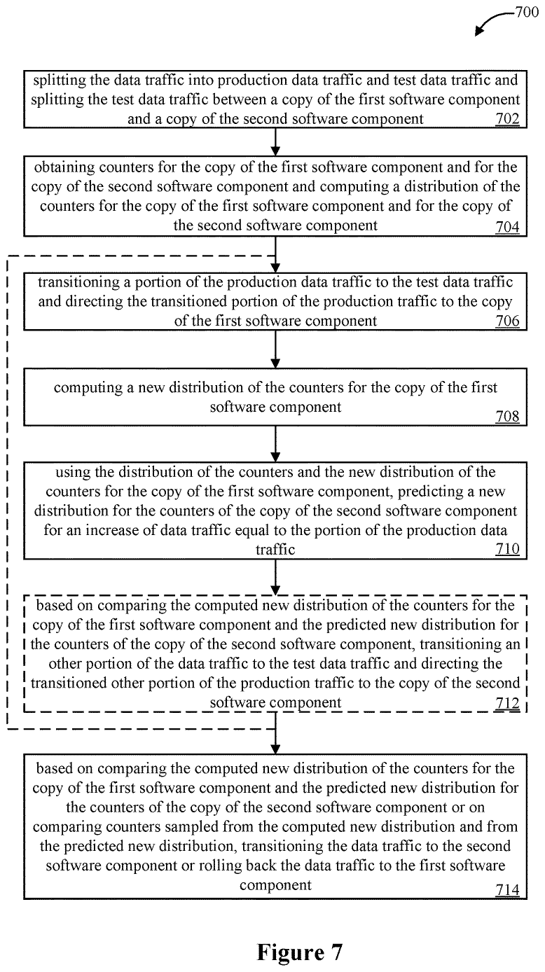

Turning to FIG. 7, there is provided a computer implemented method 700 for transitioning data traffic from a first software component to a second software component. The method comprises splitting, step 702, the data traffic into production data traffic and test data traffic and splitting the test data traffic between a copy of the first software component and a copy of the second software component. The method comprises obtaining, step 704, counters for the copy of the first software component and for the copy of the second software component and computing a distribution of the counters for the copy of the first software component and for the copy of the second software component. It should be noted that the computed distribution is an empirical distribution. The method comprises transitioning, step 706, a portion of the production data traffic to the test data traffic and directing the transitioned portion of the production traffic to the copy of the first software component. The method comprises computing, step 708, a new distribution of the counters for the copy of the first software component. The method comprises, using the distribution of the counters and the new distribution of the counters for the copy of the first software component, predicting, step 710, a new distribution for the counters of the copy of the second software component for an increase of data traffic equal to the portion of the production data traffic. The method comprises, based on comparing the computed new distribution of the counters for the copy of the first software component and the predicted new distribution for the counters of the copy of the second software component or on comparing counters sampled from the computed new distribution and from the predicted new distribution, transitioning, step 714, the data traffic to the second software component or rolling back the data traffic to the first software component. It should be noted that when a new distribution is predicted, new counters are predicted as well.

In one embodiment, the elements described in FIG. 7 correspond to the terms from the previous section of the description in the following manner:
first software component=software in production;
second software component=upgraded software version;
copy of the first software component=baseline;
copy of the second software component=canary;
production data traffic=traffic that go in the software in production;
test data traffic=traffic that is split between the baseline and the canary;
distribution of the counters for the copy of the first software component=bₜ;
distribution of the counters for the copy of the second software component=cₜ;
new distribution of the counters for the copy of the first software component=bₜ₊₁; and
new distribution of the counters for the copy of the second software component=cₜ₊₁.

The method may be read as a method for transitioning data traffic from a first software component to a second software component. The data traffic is split into production data traffic and test data traffic, which is then split between a baseline component and a canary component. Counters are obtained for the baseline and canary components, and a distribution of the counters is computed for the baseline and canary components. An additional portion of the production data traffic is transitioned to the baseline component and a new distribution of the counters is computed for the baseline component. Using the distribution and new distribution of the counters for the baseline component, a new distribution for the counters is predicted for the canary component for an equal increase of data traffic. Depending on the predicted new distribution, the data traffic is transitioned to the second software component or is rolled back to the first software component.

The method may further comprise, after the step of using, based on comparing the computed new distribution of the counters for the copy of the first software component and the predicted new distribution for the counters of the copy of the second software component, transitioning, step 712, an other portion of the data traffic to the test data traffic and directing the transitioned other portion of the production traffic to the copy of the second software component and repeating the steps of transitioning, computing, using and the previous step iteratively.

The first and second software components may be different versions of a same software component. The counters may be key performance indicators (KPIs) derived from outputs of software components.

The KPIs may include any one or more of a number of data radio bearer (DRB) packets discarded in downlink or uplink because of reasons not associated with a link object, a total number of packets received for each of a plurality of quality class indicators from an uplink radio processing user plane, a total number of packets transmitted for each of a plurality of quality class indicators to an SlU uplink, a total number of packets received for each of a plurality of quality class indicator from S1U downlink, and a total number of packets transmitted for each of a plurality of quality class indicator to a downlink radio processing user plane. A person skilled in the art would understand that other KPIs or combinations of KPIs could alternatively be used.

The step of predicting a new distribution for the counters of the copy of the second software component may comprise learning a mapping between the distribution of the counters for the copy of the first software component and the new distribution of the counters for the copy of the first software component and using transfer learning, predicting the new distribution for the counters of the copy of the second software component. If should be noted that the new distribution is based on new counters.

The step of predicting a new distribution for the counters of the copy of the second software component may comprise learning a mapping between counters sampled from the distribution of the counters for the copy of the first software component and counters sampled from the new distribution of the counters for the copy of the first software component and using transfer learning, predicting the new distribution for the counters of the copy of the second software component.

The step of predicting a new distribution for the counters of the copy of the second software component may comprise learning a pushforward by doing an inverse sampling from a discrete cumulative distribution function (CDF) from the new distribution of the counters for the copy of the first software component and from the counters for the copy of the first software component to learn a mapping between counters sampled from the distribution of the counters for the copy of the first software component and counters sampled from the new distribution of the counters for the copy of the first software component and, using transfer learning, predicting the new distribution for the counters of the copy of the second software component.

Comparing the computed new distribution of the counters for the copy of the first software component and the predicted new distribution for the counters of the copy of the second software component or comparing counters sampled from the computed new distribution and from the predicted new distribution may comprise performing a one-sided statistical test. The one-sided statistical test may consist of one of a comparison of mean values, and a use of the earth mover's distance.

The learning a mapping between the distribution of the counters for the copy of the first software component and the new distribution of the counters for the copy of the first software component may comprise learning a mapping that minimizes a distance between the distribution and the new distribution.

The learning the mapping that minimizes a distance between the distribution and the new distribution may comprise learning the mapping using transfer learning.

The learning the mapping that minimizes a distance between the distribution and the new distribution may comprise computing probability mass functions for counters sampled from the distribution of the counters for the copy of the first software component and for counters sampled from the new distribution for the counters of the copy of the first software component and finding the mapping between the probability mass functions as a solution to a linear programming problem.

It should be noted that methods and steps described herein are, generally, computer implemented methods and steps. The term computer may be interpreted as having different meanings, such as explained next, for example.

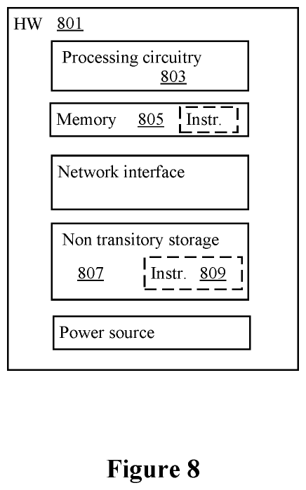

Referring to FIG. 8, there is provided a system (HW) 801, in which functions and steps described herein can be implemented.

The system 801 may be a server, network node, radio base station, or other computing device which may be part of a cloud computing system, edge computing system, or which may be a standalone device.

The method for transitioning data traffic from a first software component to a second software component may be used to update any software component handling a volume of requests or traffic running on any of the types of hardware enumerated previously. By using the canary testing technique described herein, a smooth software transition can be achieved with minimal disturbance to the system, hardware or device.

The system 801 comprises processing circuitry 803 and memory 805. The memory 805 can contain instructions executable by the processing circuitry 803 whereby functions and steps described herein may be executed to provide any of the relevant features and benefits disclosed herein.

The system 801 may also include non-transitory, persistent, machine-readable storage media 807 having stored therein software and/or instruction 809 executable by the processing circuitry 803 to execute functions and steps described herein. The system may also include network interface(s) and a power source.

The instructions 809 may include a computer program for configuring the processing circuitry 803. The computer program may be stored in a physical memory local to the device, which can be removable, or it could alternatively, or in part, be stored in the cloud. The computer program may also be embodied in a carrier such as an electronic signal, optical signal, radio signal, or computer readable storage medium.

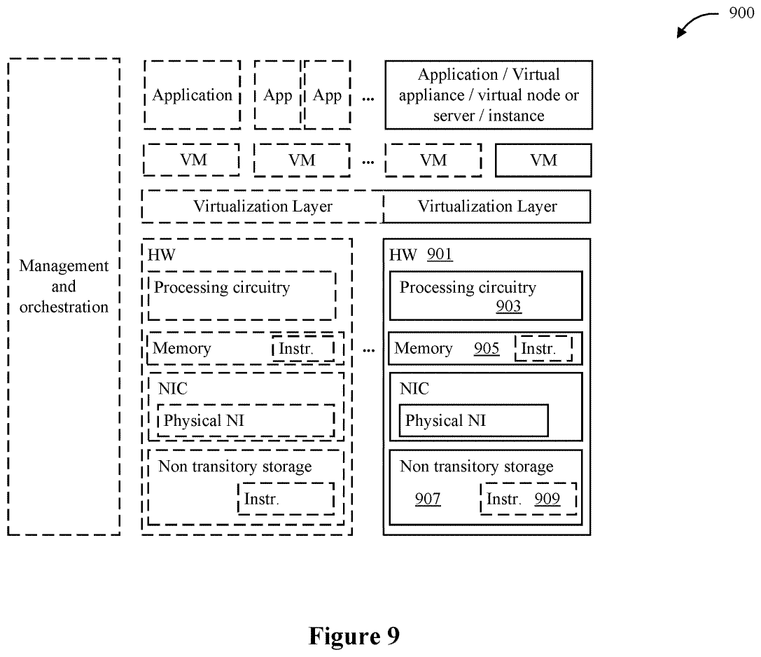

Referring to FIG. 9, there is provided a virtualization environment 900 in which functions and steps described herein can be implemented.

The virtualization environment 900 (which may go beyond what is illustrated in FIG. 9), may comprise systems, networks, servers, nodes, devices, etc., that are in communication with each other either through wire or wirelessly, e.g., through a network interface component (NIC) comprising physical network interface(s). Some or all of the functions and steps described herein may be implemented as one or more virtual components (e.g., via one or more applications, components, functions, virtual machines, containers, etc.) executing on one or more physical apparatus in one or more networks, systems, environment, etc.

A virtualization environment provides hardware 901 comprising processing circuitry 903 and memory 905. The memory 905 can contain instructions executable by the processing circuitry 903 whereby functions and steps described herein may be executed to provide any of the relevant features and benefits disclosed herein.

The hardware 901 may also include non-transitory, persistent, machine-readable storage media 907 having stored therein software and/or instruction 909 executable by the processing circuitry 903 to execute functions and steps described herein.

The instructions 909 may include a computer program for configuring the processing circuitry 903. The computer program may be stored in a removable memory, such as a portable compact disc, portable digital video disc, or other removable media. The computer program may be stored in a physical memory local to the hardware 901, which can be removable, or it could alternatively, or in part, be stored in the cloud. The computer program may also be embodied in a carrier such as an electronic signal, optical signal, radio signal, or computer readable storage medium.

Referring again to FIGS. 8 and 9, there is provided a system 801, 900 operative to transition data traffic from a first software component to a second software component. The system comprises processing circuitry 803, 903 and a memory 805, 905, the memory containing instructions executable by the processing circuitry whereby the system is operative to split the data traffic into production data traffic and test data traffic and split the test data traffic between a copy of the first software component and a copy of the second software component. The system is operative to obtain counters for the copy of the first software component and for the copy of the second software component and compute a distribution of the counters for the copy of the first software component and for the copy of the second software component. The system is operative to transition a portion of the production data traffic to the test data traffic and direct the transitioned portion of the production traffic to the copy of the first software component. The system is operative to compute a new distribution of the counters for the copy of the first software component. The system is operative to use the distribution of the counters and the new distribution of the counters for the copy of the first software component to predict a new distribution for the counters of the copy of the second software component for an increase of data traffic equal to the portion of the production data traffic. The system is operative to, based on comparing the computed new distribution of the counters for the copy of the first software component and the predicted new distribution for the counters of the copy of the second software component or on comparing counters sampled from the computed new distribution and from the predicted new distribution, transition the data traffic to the second software component or rolling back the data traffic to the first software component.

The system is further operative to, based on comparing the computed new distribution of the counters for the copy of the first software component and the predicted new distribution for the counters of the copy of the second software component, transition an other portion of the data traffic to the test data traffic and direct the transitioned other portion of the production traffic to the copy of the second software component.

The first and second software components may be different versions of a same software component. The counters may be key performance indicators (KPIs) derived from outputs of software components. The KPIs may include any one or more of a number of data radio bearer (DRB) packets discarded in downlink or uplink because of reasons not associated with a link object, a total number of packets received for each of a plurality of quality class indicators from an uplink radio processing user plane, a total number of packets transmitted for each of a plurality of quality class indicators to an SlU uplink, a total number of packets received for each of a plurality of quality class indicator from SlU downlink and a total number of packets transmitted for each of a plurality of quality class indicator to a downlink radio processing user plane.

The system is further operative to learn a mapping between the distribution of the counters for the copy of the first software component and the new distribution of the counters for the copy of the first software component and, using transfer learning, predict the new distribution for the counters of the copy of the second software component.

The system is further operative to learn a mapping between counters sampled from the distribution of the counters for the copy of the first software component and counters sampled from the new distribution of the counters for the copy of the first software component and, using transfer learning, predict the new distribution for the counters of the copy of the second software component.

The system is further operative to learn a pushforward by doing an inverse sampling from a discrete cumulative distribution function (CDF) from the new distribution of the counters for the copy of the first software component and from the counters for the copy of the first software component to learn a mapping between counters sampled from the distribution of the counters for the copy of the first software component and counters sampled from the new distribution of the counters for the copy of the first software component and, using transfer learning, predict the new distribution for the counters of the copy of the second software component.

The system is further operative to perform a one-sided statistical test. The one-sided statistical test may consist of one of a comparison of mean values, and a use of the earth mover's distance.

The system is further operative to learn a mapping that minimizes a distance between the distribution and the new distribution. The system is further operative to learn the mapping using transfer learning.

The system is further operative to compute probability mass functions for counters sampled from the distribution of the counters for the copy of the first software component and for counters sampled from the new distribution for the counters of the copy of the first software component and find the mapping between the probability mass functions as a solution to a linear programming problem.

Still referring to FIGS. 8 and 9, there is provided a non-transitory computer readable media 807, 907 having stored thereon instructions 809, 909 for transitioning data traffic from a first software component to a second software component. The instructions 809, 909 comprise splitting the data traffic into production data traffic and test data traffic and splitting the test data traffic between a copy of the first software component and a copy of the second software component. The instructions 809, 909 comprise obtaining counters for the copy of the first software component and for the copy of the second software component and computing a distribution of the counters for the copy of the first software component and for the copy of the second software component. The instructions 809, 909 comprise transitioning a portion of the production data traffic to the test data traffic and directing the transitioned portion of the production traffic to the copy of the first software component. The instructions 809, 909 comprise computing a new distribution of the counters for the copy of the first software component. The instructions 809, 909 comprise using the distribution of the counters and the new distribution of the counters for the copy of the first software component, predicting a new distribution for the counters of the copy of the second software component for an increase of data traffic equal to the portion of the production data traffic. The instructions 809, 909 comprise based on comparing the computed new distribution of the counters for the copy of the first software component and the predicted new distribution for the counters of the copy of the second software component or on comparing counters sampled from the computed new distribution and from the predicted new distribution, transitioning the data traffic to the second software component or rolling back the data traffic to the first software component.

The non-transitory computer readable media 807, 907 may further have stored thereon instructions 809, 909 for executing any of the steps described herein.

Modifications will come to mind to one skilled in the art having the benefit of the teachings presented in the foregoing description and the associated drawings. Therefore, it is to be understood that modifications, such as specific forms other than those described above, are intended to be included within the scope of this disclosure. The previous description is merely illustrative and should not be considered restrictive in any way. The scope sought is given by the appended claims, rather than the preceding description, and all variations and equivalents that fall within the range of the claims are intended to be embraced therein. Although specific terms may be employed herein, they are used in a generic and descriptive sense only and not for purposes of limitation.

1. A computer implemented method for transitioning data traffic from a first software component to a second software component, comprising:
splitting the data traffic into production data traffic and test data traffic and splitting the test data traffic between a copy of the first software component and a copy of the second software component;
obtaining counters for the copy of the first software component and for the copy of the second software component and computing a distribution of the counters for the copy of the first software component and for the copy of the second software component;
transitioning a portion of the production data traffic to the test data traffic and directing the transitioned portion of the production traffic to the copy of the first software component;
computing a new distribution of the counters for the copy of the first software component;
using the distribution of the counters and the new distribution of the counters for the copy of the first software component, predicting a new distribution for the counters of the copy of the second software component for an increase of data traffic equal to the portion of the production data traffic;
based on comparing the computed new distribution of the counters for the copy of the first software component and the predicted new distribution for the counters of the copy of the second software component or on comparing counters sampled from the computed new distribution and from the predicted new distribution, transitioning the data traffic to the second software component or rolling back the data traffic to the first software component.

2. The method of claim 1, further comprising, after the step of using:
based on comparing the computed new distribution of the counters for the copy of the first software component and the predicted new distribution for the counters of the copy of the second software component, transitioning an other portion of the data traffic to the test data traffic and directing the transitioned other portion of the production traffic to the copy of the second software component; and
repeating the steps of transitioning, computing, using and the previous step iteratively.

3. The method of claim 1, wherein the first and second software components are different versions of a same software component.

4. The method claim 1, wherein the counters are key performance indicators (KPIs) derived from outputs of software components.

5. The method of claim 4, wherein the KPIs include any one or more of:
a number of data radio bearer (DRB) packets discarded in downlink or uplink because of reasons not associated with a link object;
a total number of packets received for each of a plurality of quality class indicators from an uplink radio processing user plane;
a total number of packets transmitted for each of a plurality of quality class indicators to an S1U uplink;
a total number of packets received for each of a plurality of quality class indicator from S1U downlink; and
a total number of packets transmitted for each of a plurality of quality class indicator to a downlink radio processing user plane.

6. The method claim 1, wherein the step of predicting a new distribution for the counters of the copy of the second software component further comprises:
learning a mapping between the distribution of the counters for the copy of the first software component and the new distribution of the counters for the copy of the first software component; and
using transfer learning, predicting the new distribution for the counters of the copy of the second software component.

7. The method claim 1, wherein the step of predicting a new distribution for the counters of the copy of the second software component further comprises:
learning a mapping between counters sampled from the distribution of the counters for the copy of the first software component and counters sampled from the new distribution of the counters for the copy of the first software component; and
using transfer learning, predicting the new distribution for the counters of the copy of the second software component.

8. The method claim 1, wherein the step of predicting a new distribution for the counters of the copy of the second software component further comprises:
learning a pushforward by doing an inverse sampling from a discrete cumulative distribution function (CDF) from the new distribution of the counters for the copy of the first software component and from the counters for the copy of the first software component to learn a mapping between counters sampled from the distribution of the counters for the copy of the first software component and counters sampled from the new distribution of the counters for the copy of the first software component; and
using transfer learning, predicting the new distribution for the counters of the copy of the second software component.

9. The method claim 1, wherein comparing the computed new distribution of the counters for the copy of the first software component and the predicted new distribution for the counters of the copy of the second software component or comparing counters sampled from the computed new distribution and from the predicted new distribution comprises performing a one-sided statistical test.

10. The method of claim 9, wherein the one-sided statistical test consists of one of a comparison of mean values, and a use of the earth mover's distance.

11. (canceled)

12. (canceled)

13. (canceled)

14. A system operative to transition data traffic from a first software component to a second software component, the system comprising processing circuitry and a memory, the memory containing instructions executable by the processing circuitry whereby the system is operative to:
split the data traffic into production data traffic and test data traffic and split the test data traffic between a copy of the first software component and a copy of the second software component;
obtain counters for the copy of the first software component and for the copy of the second software component and compute a distribution of the counters for the copy of the first software component and for the copy of the second software component;
transition a portion of the production data traffic to the test data traffic and direct the transitioned portion of the production traffic to the copy of the first software component;
compute a new distribution of the counters for the copy of the first software component;
use the distribution of the counters and the new distribution of the counters for the copy of the first software component to predict a new distribution for the counters of the copy of the second software component for an increase of data traffic equal to the portion of the production data traffic;
based on comparing the computed new distribution of the counters for the copy of the first software component and the predicted new distribution for the counters of the copy of the second software component or on comparing counters sampled from the computed new distribution and from the predicted new distribution, transition the data traffic to the second software component or roll back the data traffic to the first software component.

15. The system of claim 14, further operative to, based on comparing the computed new distribution of the counters for the copy of the first software component and the predicted new distribution for the counters of the copy of the second software component, transition an other portion of the data traffic to the test data traffic and direct the transitioned other portion of the production traffic to the copy of the second software component.

16. The system of claim 14, wherein the first and second software components are different versions of a same software component.

17. The system of claim 14, wherein the counters are key performance indicators (KPIs) derived from outputs of software components.

18. The system of claim 17, wherein the KPIs include any one or more of:
a number of data radio bearer (DRB) packets discarded in downlink or uplink because of reasons not associated with a link object;
a total number of packets received for each of a plurality of quality class indicators from an uplink radio processing user plane;
a total number of packets transmitted for each of a plurality of quality class indicators to an S1U uplink;
a total number of packets received for each of a plurality of quality class indicator from S1U downlink; and
a total number of packets transmitted for each of a plurality of quality class indicator to a downlink radio processing user plane.

19. The system claim 14, further operative to:
learn a mapping between the distribution of the counters for the copy of the first software component and the new distribution of the counters for the copy of the first software component; and
using transfer learning, predict the new distribution for the counters of the copy of the second software component.

20. The system of claim 14, further operative to:
learn a mapping between counters sampled from the distribution of the counters for the copy of the first software component and counters sampled from the new distribution of the counters for the copy of the first software component; and
using transfer learning, predict the new distribution for the counters of the copy of the second software component.

21. The system of claim 14, further operative to:
learn a pushforward by doing an inverse sampling from a discrete cumulative distribution function (CDF) from the new distribution of the counters for the copy of the first software component and from the counters for the copy of the first software component to learn a mapping between counters sampled from the distribution of the counters for the copy of the first software component and counters sampled from the new distribution of the counters for the copy of the first software component; and
using transfer learning, predict the new distribution for the counters of the copy of the second software component.

22. The system of claim 14, further operative to perform a one-sided statistical test, wherein the one-sided statistical test consists of one of a comparison of mean values, and a use of the earth mover's distance.

23. (canceled)

24. (canceled)

25. (canceled)

26. (canceled)

27. A non-transitory computer readable media having stored thereon instructions for transitioning data traffic from a first software component to a second software component, the instructions comprising:
splitting the data traffic into production data traffic and test data traffic and splitting the test data traffic between a copy of the first software component and a copy of the second software component;
obtaining counters for the copy of the first software component and for the copy of the second software component and computing a distribution of the counters for the copy of the first software component and for the copy of the second software component;
transitioning a portion of the production data traffic to the test data traffic and directing the transitioned portion of the production traffic to the copy of the first software component;
computing a new distribution of the counters for the copy of the first software component;
using the distribution of the counters and the new distribution of the counters for the copy of the first software component, predicting a new distribution for the counters of the copy of the second software component for an increase of data traffic equal to the portion of the production data traffic;
based on comparing the computed new distribution of the counters for the copy of the first software component and the predicted new distribution for the counters of the copy of the second software component or on comparing counters sampled from the computed new distribution and from the predicted new distribution, transitioning the data traffic to the second software component or rolling back the data traffic to the first software component.

28. (canceled)
